(19) United States
(12) Patent Application Publication
(10) Pub. No.: US 2005/0251580 A1
(43) Pub. Date: Nov. 10, 2005

(54) System and method for efficiently implementing processed data structures in an electronic network

(75) Inventor: Edgar A. Tu, Castro Valley, CA (US)

Correspondence Address: Gregory J. Koerner;Redwood Patent Law, 1291 East Hillsdale Boulevard, Suite 205, Foster City, CA, 94404, US

(73) Assignee: Sony Computer Entertainment Inc.

(21) Appl. No.: 10/915,053

(22) Filed: Aug. 10, 2004

Related U.S. Application Data
(60) Provisional application No. 60/569,731, filed on May 10, 2004.

(51) Int. Cl. G06F 15/16

(52) U.S. Cl. 709/236

(57) ABSTRACT

A system and method for efficiently implementing processed data structures in an electronic network may include a device server and a peer-to-peer network of electronics devices which may be divided into first-tier devices and second tier devices. The device server may be configured to access raw data from a data source, and may then divide the raw data into unprocessed data segments. Each of the first-tier devices may download one of the unprocessed data segments from the device server, and may then perform a distributed processing procedure to convert the unprocessed data segments into processed data segments according to certain pre-defined processing rules. The first-tier devices and the second-tier devices may then performing a data reassembly procedure through the peer-to-peer network to thereby populate respective processed data structures on each of the electronic devices with complete sets of the processed data segments.

### CROSS-REFERENCE TO RELATED APPLICATIONS

This Application relates to, and claims priority in, U.S. Provisional patent application Ser. No. 60/569,731, entitled, “System And Method For Efficiently Implementing Processed Data Structures In An Electronic Network,” filed on May 10, 2004. The foregoing related application is commonly assigned, and is hereby incorporated by reference.

### BACKGROUND SECTION

1. Field of the Invention

This invention relates generally to techniques for managing electronic information, and relates more particularly to a system and method for efficiently implementing processed data structures in an electronic network.

2. Description of the Background Art

Implementing effective methods for managing electronic information is a significant consideration for designers and manufacturers of contemporary electronic devices. However, effectively managing information utilized by devices in an electronic network may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced management operations may provide additional benefits to a system user, but may also place increased demands on the control and management of various system components. For example, an enhanced electronic network device that effectively manages digital program guide data may benefit from an efficient implementation because of the large amount and complexity of the digital data involved.

Designing electronic devices that provide various types of enhanced device functionality while still maintaining a sufficient level of user-friendliness and ease-of-operation is another significant consideration when implementing electronic devices for use in certain environments in which the relative level of technical sophistication of device users is not particularly high. In addition, various types of streamlined and automated functionalities may be beneficial in order to allow device users to advantageously utilize their time and energy for performing other productive tasks.

Due to growing demands on system resources and substantially increasing data magnitudes, it is apparent that developing new techniques for managing information in electronic networks is a matter of concern for related electronic technologies. Therefore, for all the foregoing reasons, developing effective techniques for managing information in electronic networks remains a significant consideration for designers, manufacturers, and users of contemporary electronic devices.

### SUMMARY

In accordance with the present invention, a system and method for efficiently implementing processed data structures in an electronic network are disclosed. In one embodiment, initially, any appropriate collecting entity or entities may collect raw data by utilizing any effective techniques or methodologies. For example, in certain embodiments, the raw data may include unprocessed electronic program guide information which may be collected from various programming networks and related network affiliates. The foregoing collecting entity may provide the raw data to a data source which may be implemented in any effective manner. For example, in certain embodiments, the data source may be implemented as an Internet website.

A device server may then access the data source to download the raw data to a server memory associated with the device server. The device server may advantageously utilize a server application or other appropriate entity to divide the raw data from the data source into corresponding unprocessed data segments by utilizing any appropriate techniques. In accordance with the present invention, certain first-tier devices from a peer-to-peer network may each download a different respective unprocessed data segment from the device server. Then, the first-tier devices may perform a distributed processing procedure by each utilizing a respective processing manager to change the unprocessed data segments into corresponding processed data segments by applying appropriate pre-determined processing rules.

The first-tier devices and other second-tier devices of the peer-to-peer network may then begin a data reassembly procedure to produce corresponding processed data structures by repeatedly sending queries to other first-tier devices and second-tier devices in the peer-to-peer network to request missing processed data segments for completing their respective processed data structures.

The first-tier devices and second-tier devices of the peer-to-peer network may continue to populate their respective processed data structures with processed data segments received as a result of the foregoing queries. When the respective processed data structures have been successfully populated with a complete set of processed data segments, then corresponding system users may utilize the processed data structures for any appropriate purposes. The present invention thus provides an efficient system and method for implementing processed data structures in an electronic network.

### BRIEF DESCRIPTION OF THE DRAWINGS

FIG. 1 is a block diagram of an electronic network, in accordance with one embodiment of the present invention;

FIG. 2 is a block diagram for one embodiment of the device server of FIG. 1, in accordance with the present invention;

FIG. 3 is a block diagram for one embodiment of the device memory of FIG. 2, in accordance with the present invention;

FIG. 4 is a block diagram for one embodiment of the unprocessed data segments of FIG. 3, in accordance with the present invention;

FIG. 5 is a block diagram for one embodiment of the electronic devices of FIG. 1, in accordance with the present invention;

FIG. 6 is a block diagram for one embodiment of an entertainment device, in accordance with the present invention;

FIG. 7 is a block diagram for one embodiment of the device memory of FIG. 5, in accordance with the present invention;

FIG. 8 is a block diagram for one embodiment of the processed data structure of FIG. 7, in accordance with the present invention;

FIG. 9 is a flowchart of initial method steps for efficiently implementing processed data structures an electronic network, in accordance with one embodiment of the present invention; and

FIG. 10 is a flowchart of final method steps for efficiently implementing processed data structures in an electronic network, in accordance with one embodiment of the present invention.

### DETAILED DESCRIPTION

The present invention relates to an improvement in electronic information management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for efficiently implementing processed data structures in an electronic network, and may include a device server and a peer-to-peer network of electronics devices which may be divided into first-tier devices and second tier devices. The device server may be configured to access raw data from a data source, and may then divide the raw data into unprocessed data segments. Each of the first-tier devices may download one of the unprocessed data segments from the device server, and may then perform a distributed processing procedure to convert the unprocessed data segments into processed data segments according to certain pre-defined processing rules. The first-tier devices and the second-tier devices may then performing a data reassembly procedure through the peer-to-peer network to thereby populate respective processed data structures on each of the electronic devices with complete sets of the processed data segments.

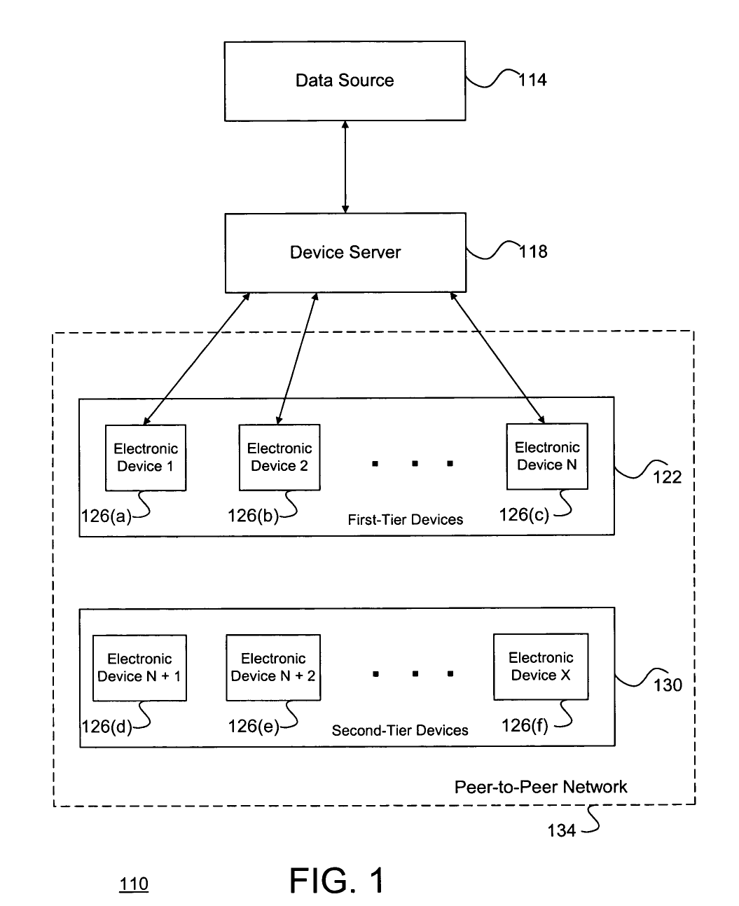

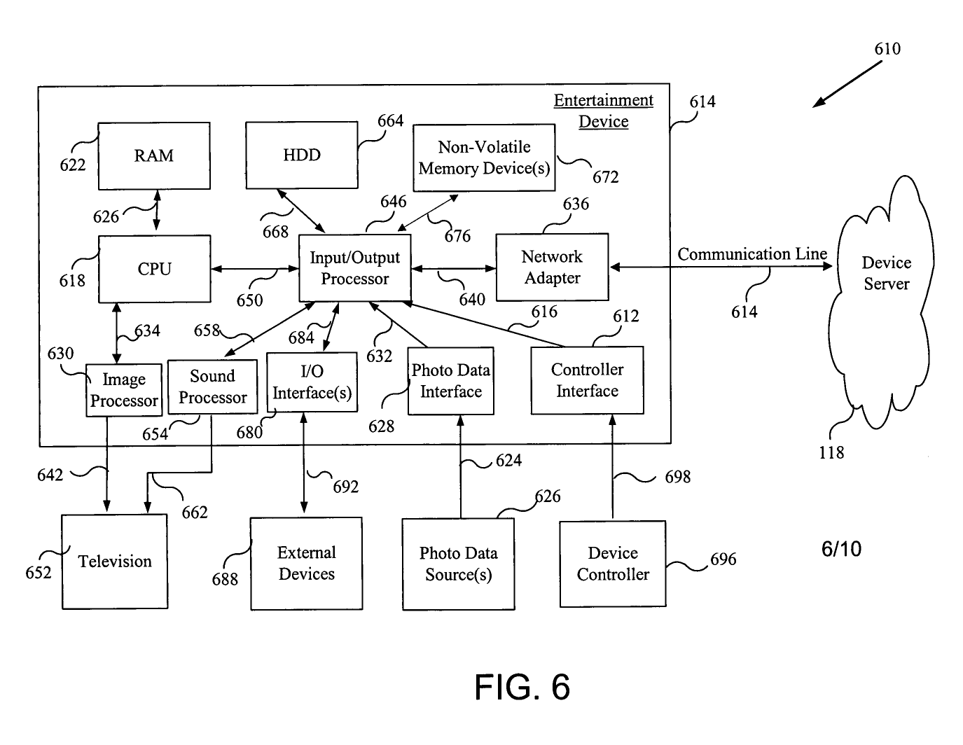

Referring now to FIG. 1, a block diagram of an electronic network 110 is shown, in accordance with one embodiment of the present invention. In the FIG. 1 embodiment, electronic network 110 may include, but is not limited to, a data source 114, a device server 118, and a plurality of electronic devices 126. In alternate embodiments, electronic network 110 may readily be implemented by utilizing various components and configurations in addition to, or instead of, those discussed in conjunction with the FIG. 1 embodiment. Furthermore, in the FIG. 1 embodiment, electronic devices 126 may be implemented as any type of appropriate electronic devices. For example, in certain embodiments, electronic devices 126 may be implemented as stationary or portable consumer-electronics entertainment devices, as further discussed below in conjunction with FIG. 6.

In the FIG. 1 embodiment, data source 114 may be implemented as any appropriate entity for providing any type of data or other information to device server 118. In the FIG. 1 embodiment, raw data stored on data source 114 may include any desired type of data or other information that is provided in any appropriate format. For example, in certain embodiments of the present invention, data source 114 may be implemented as an Internet website that stores raw program data that has been collected from any number of different entertainment program scheduling entities to thereby provide a comprehensive set of raw entertainment program scheduling data for a designated programming area or region.

In the FIG. 1 embodiment, device server 118 may access the foregoing raw data from data source 114, and may then divide the raw data into individual unprocessed data segments which may each be downloaded by one or more electronic devices 126 from first-tier devices 122 of a peer-to-peer network 134. In the FIG. 1 embodiment, first-tier devices 122 may include an electronic device 1 (126(a)) through an electronic device N 126(c). In accordance with the present invention, first-tier devices 122 may then perform a distributed processing procedure by processing their respective unprocessed data segments according to predefined processing rules to thereby efficiently produce corresponding processed data segments.

In the FIG. 1 embodiment, first-tier devices 122 and second-tier devices 130 may then perform a data reassembly procedure to create identical processed data structures of processed data segments on each of the electronic devices 126. In the FIG. 1 embodiment, second-tier devices 130 may include a electronic device N+1 (126(d)) through an electronic device X (126(f). In the FIG. 1 embodiment, the foregoing data reassembly procedure may be performed in any appropriate manner to effectively produce a final processed data structure that includes a complete set of the different processed data segments that have been separately processed by respective first-tier devices 122.

In certain embodiments, first-tier devices 122 and second-tier devices 130 may perform the foregoing data reassembly procedure by each repetitively sending appropriate queries to other selected electronic devices 126 in peer-to-peer network 134. The first-tier devices 122 and second-tier devices 130 may request any missing processed data segments for completely populating corresponding respective processed data structures with a full set of the data segments that were derived during the distributed processing procedure from the raw data originally received from data source 114. In the FIG. 1 embodiment, electronic devices 126 may bi-directionally communicate directly with each other by utilizing any desired peer-to-peer communication techniques or other effective communication methods.

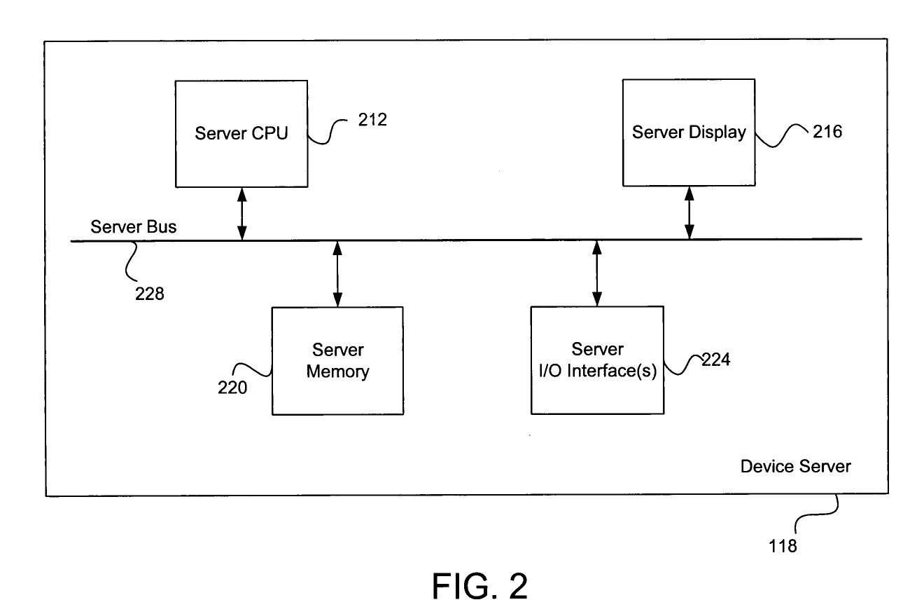

In the FIG. 1 embodiment, the foregoing final processed data structures may include any type of data that may be utilized for any appropriate purpose. For example, in an embodiment in which the raw data received from data source 114 includes comprehensive raw program guide data for various collected entertainment programming or other types of scheduling, then the final processed data structures that are processed and distributed by electronic devices 126 in peer-to-peer network 134 may be implemented as electronic program guides for utilization by corresponding system users to select, record, and view desired entertainment programming or other types of appropriate scheduled events. Further details regarding the implementation and utilization of the FIG. 1 electronic network 110 are discussed below in conjunction with FIG. 2 through FIG. 10.

Referring now to FIG. 2, a block diagram for one embodiment of the FIG. 1 device server 118 is shown, in accordance with the present invention. In the FIG. 2 embodiment, device server 118 may include, but is not limited to, a server central processing unit (server CPU) 212, a server display 216, a server memory 220, and one or more server input/output interface(s) (server I/O interface(s)) 224. The foregoing components of device server 118 may be coupled to, and communicate through, a server bus 228. In alternate embodiments, device server 118 may readily be implemented using various components and configurations in addition to, or instead of, those discussed in conjunction with the FIG. 2 embodiment.

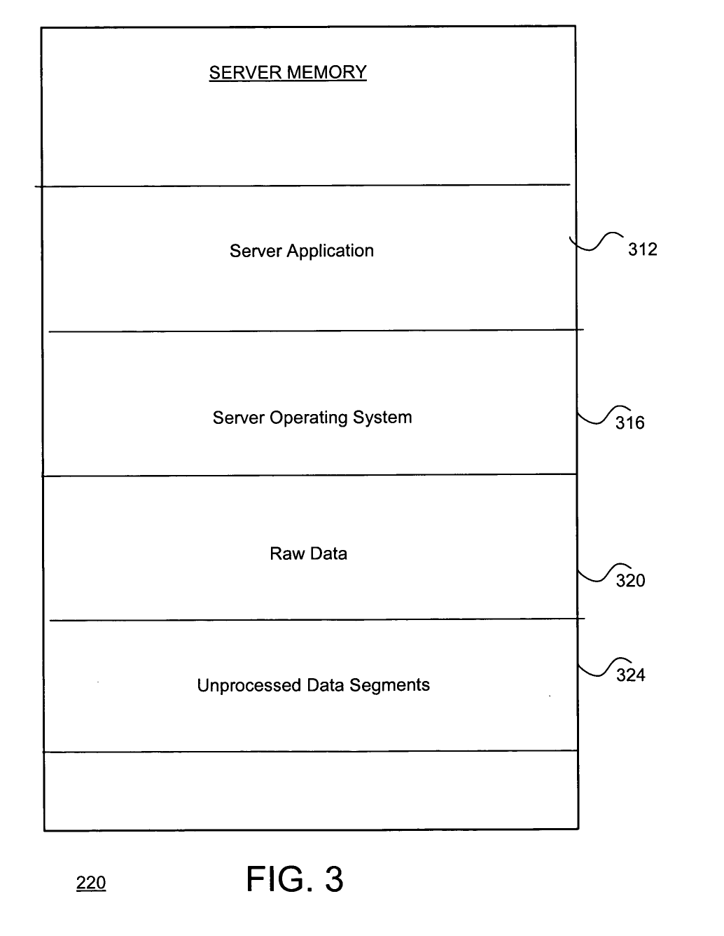

In the FIG. 2 embodiment, server CPU 212 may be implemented to include any appropriate and compatible microprocessor device that preferably executes software instructions to thereby control and manage the operation of device server 118. The FIG. 2 server display 216 may include any effective type of display technology including a cathode-ray-tube monitor or a liquid-crystal display device with an appropriate screen for displaying various information to a server user. In the FIG. 2 embodiment, server memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of server memory 220 are further discussed below in conjunction with FIG. 3.

In the FIG. 2 embodiment, server I/O interface(s) 224 may include one or more input and/or output interfaces to receive and/or transmit any required types of information by device server 118. Server I/O interface(s) 224 may include one or more means for allowing a server user to communicate with device server 118. The implementation and utilization of device server 118 is further discussed below in conjunction with FIGS. 3, 4, and 9.

Referring now to FIG. 3, a block diagram for one embodiment of the FIG. 2 server memory 220 is shown, in accordance with the present invention. In the FIG. 3 embodiment, server memory 220 may include, but is not limited to, a server application 312, a server operating system 316, raw data 320, and unprocessed data segments 324. In alternate embodiments, server memory 220 may readily include various other components in addition to, or instead of, those components discussed in conjunction with the FIG. 3 embodiment.

In the FIG. 3 embodiment, server application 312 may include program instructions that are preferably executed by server CPU 212 (FIG. 2) to perform various functions and operations for device server 118. The particular nature and functionality of server application 312 typically varies depending upon factors such as the specific type and particular functionality of the corresponding device server 118. Server operating system 316 may perform various low-level functions for device server 118.

In the FIG. 3 embodiment, raw data 320 may include any appropriate type of data or other information accessed by server application 312 from data source 114 (FIG. 1) or other appropriate entity. For example, in certain embodiments, raw data 320 may include raw program schedule data that has been collected from any number of different programming entities (such as television broadcasting networks or their various network affiliates) to thereby provide a comprehensive set of raw program guide information for a designated programming area or region.

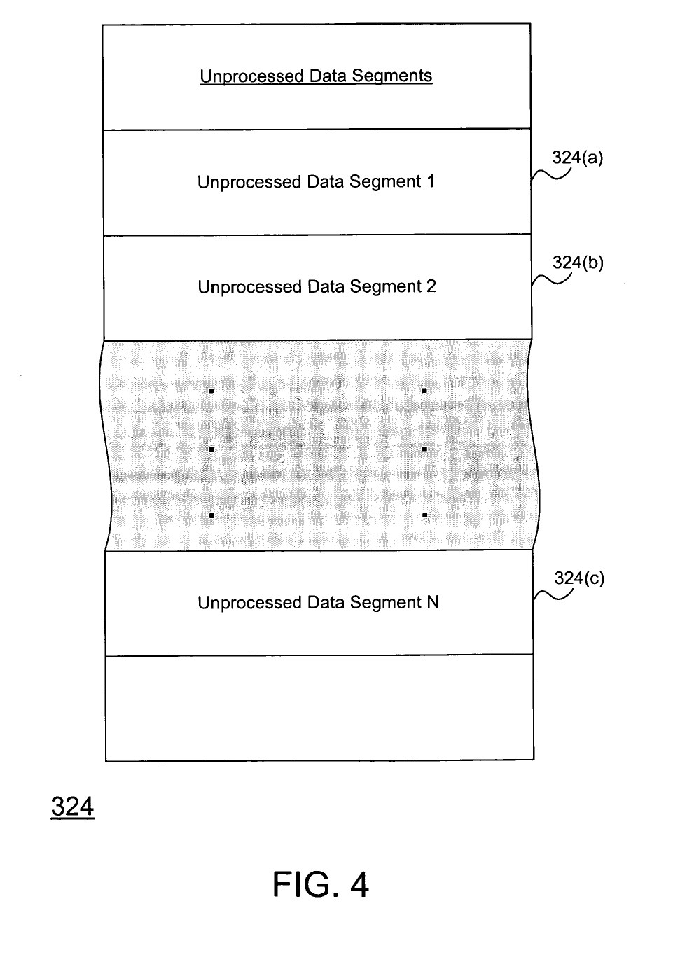

In accordance with certain embodiments of the present invention, device server 118 may utilize server application 312 or other appropriate entity to advantageously divide raw program data 320 into separate unprocessed data segments 324 by utilizing any effective techniques or methods. The utilization of unprocessed data segments 324 is further discussed below in conjunction with FIGS. 4, and 7-10.

Referring now to FIG. 4, a diagram for one embodiment of the FIG. 3 unprocessed data segments 324 is shown, in accordance with the present invention. In the FIG. 4 embodiment, unprocessed data segments 324 may include, but are not limited to, unprocessed data segment 1 (324(c)) through unprocessed data segment N 324(c). In alternate embodiments, unprocessed data segments 324 may readily include various other elements and configurations in addition to, or instead of, those elements and configurations discussed in conjunction with the FIG. 4 embodiment.

Referring again to foregoing FIG. 1 in conjunction with the unprocessed data segments 324 shown in FIG. 4, device server 118 (FIG. 1) may divide raw data 320 (FIG. 3) into unprocessed data segments 324 such as unprocessed data segment 1 (324(a)) through unprocessed data segment N 324(c) shown in the FIG. 4 embodiment. Each of first-tier devices 122 (FIG. 1) may then access device server 118 to download a corresponding one of the unprocessed data segments 324. First-tier devices 122 may then perform an efficient distributed processing procedure in parallel upon respective unprocessed data segments 324 by utilizing appropriate processing rules to thereby convert the unprocessed data segments 324 into corresponding processed data segments.

The foregoing distributed processing procedure efficiently distributes the substantial task of processing raw data 320 (FIG. 3) among a plurality of different electronic devices 126 from first-tier devices 122 (FIG. 1) instead of requiring device server 118 to process raw data 320 as a unified data structure. Device server 118 may therefore be economically and efficiently implemented as a less powerful computer system with reduced processing, memory, and bandwidth resources. Furthermore, because processing raw data 320 is distributed and performed in parallel by multiple electronic devices 126, the required processing time is significantly reduced.

After the distributed processing procedure has been completed, first-tier devices 122 and second-tier devices 122 (FIG. 1) may then perform a data reassembly procedure to populate identical processed data structures of the processed data segments on each of the electronic devices 126. In certain embodiments, first-tier devices 122 and second-tier devices 130 may perform the foregoing data reassembly procedure by each repetitively sending appropriate queries to other selected electronic devices 126 in peer-to-peer network 134 (FIG. 1). First-tier devices 122 and second-tier devices 130 may each request any missing processed data segments for completely populating corresponding respective processed data structures with a full set of the processed data segments.

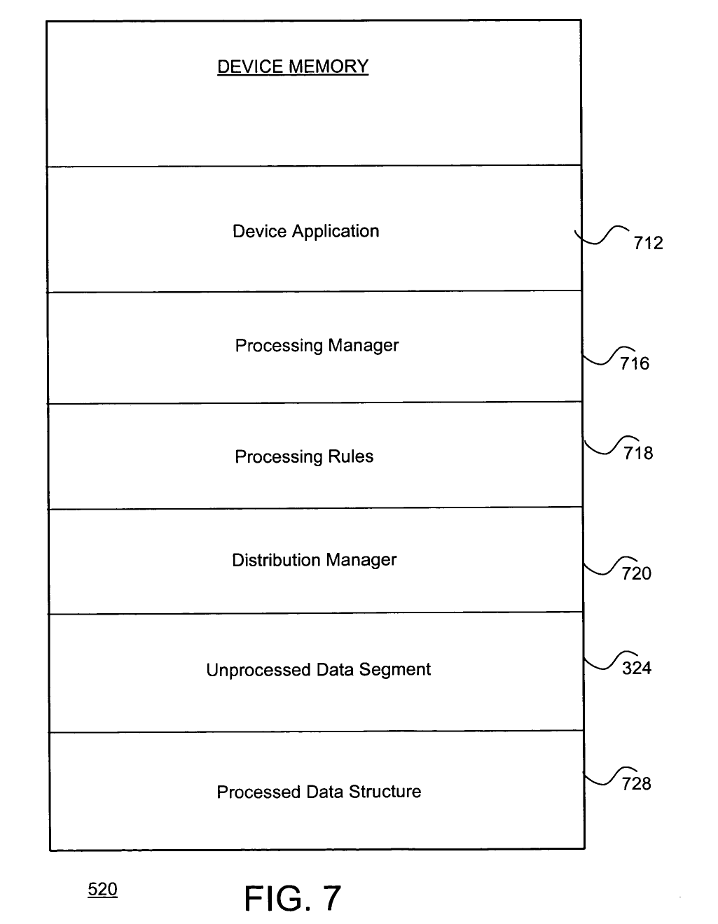

The foregoing data reassembly procedure efficiently performs the substantial task of distributing processed data segments by utilizing the different electronic devices 126 from peer-to-peer network (FIG. 1) instead of requiring device server 118 to separately distribute data to each electronic device 126 individually. Device server 118 and associated communication equipment (such as modems and communication lines) may therefore be economically and efficiently implemented as a less complex and powerful system with reduced device-connection capacity and decreased system bandwidth resources. The handling and utilization of unprocessed data segments 324 are further discussed below in conjunction with FIGS. 7-10.

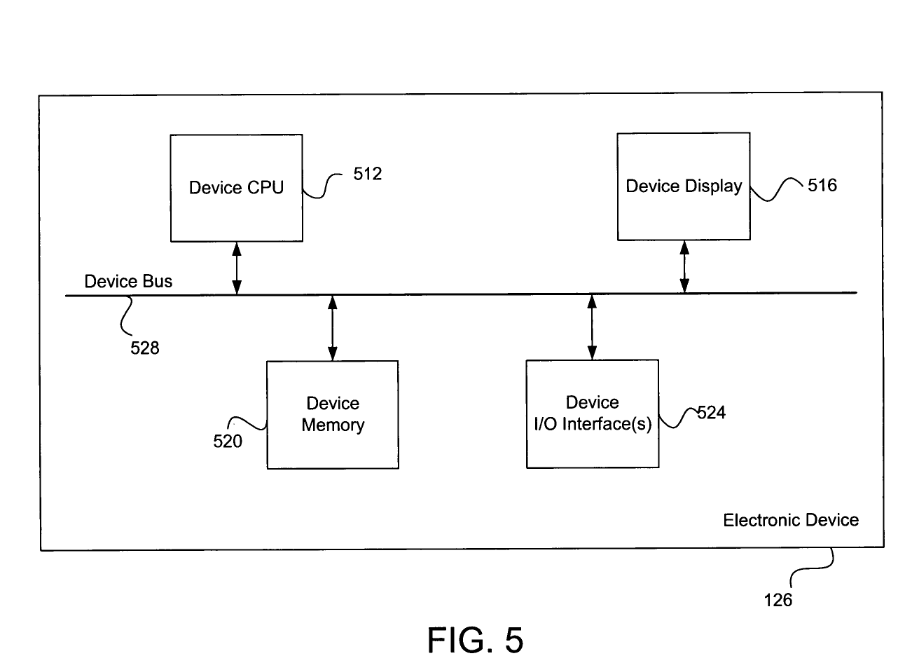

Referring now to FIG. 5, a block diagram for one embodiment of the FIG. 1 electronic devices 126 is shown, in accordance with the present invention. In the FIG. 5 embodiment, electronic device 126 may include, but is not limited to, a device central processing unit (device CPU) 512, a device display 516, a device memory 520, and one or more device input/output interface(s) (device I/O interface(s)) 524. The foregoing components of electronic device 126 may be coupled to, and communicate through, a device bus 528. In alternate embodiments, electronic device 126 may readily be implemented using various components and configurations in addition to, or instead of, those discussed in conjunction with the FIG. 5 embodiment.

In the FIG. 5 embodiment, device CPU 512 may be implemented to include any appropriate and compatible microprocessor device that preferably executes software instructions to thereby control and manage the operation of electronic devices 126. The FIG. 5 device display 516 may include any effective type of display technology including a cathode-ray-tube monitor or a liquid-crystal display device with an appropriate screen for displaying various information to a device user. In the FIG. 5 embodiment, device memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of device memory 520 are further discussed below in conjunction with FIG. 7.

In the FIG. 5 embodiment, device I/O interface(s) 524 may include one or more input and/or output interfaces to receive and/or transmit any required types of information by electronic device 126. Device I/O interface(s) 524 may include one or more means for allowing a device user to communicate with other entities in electronic network 110 (FIG. 1). For example, the foregoing means may include a keyboard device, a wireless remote-control device, a speech-recognition module with corresponding microphone, a graphical user interface with touch-screen capability, a hand-held device controller unit, or a selection button array mounted externally on electronic device 126. The implementation and utilization of electronic device 126 are further discussed below in conjunction with FIGS. 6-10.

Referring now to FIG. 6, a block diagram for one embodiment of an entertainment system 610 is shown, in accordance with certain embodiments of the present invention. The FIG. 6 entertainment system 610 may include, but is not limited to, an entertainment device 614, a television 652, various external devices 688, and at least one device controller 696. In alternate embodiments, entertainment system 610 may readily be implemented using various components, functionalities, and configurations in addition to, or instead of, those discussed in conjunction with the FIG. 6 embodiment.

In accordance with various embodiments of the present invention, entertainment device 614 may be implemented in any effective and appropriate manner. For example, in certain embodiments, entertainment device 614 may be effectively implemented as a Sony PlayStation( device. Furthermore, in certain embodiments of the present invention, the electronic devices 126 that are shown and discussed in conjunction with foregoing FIG. 1 and FIG. 5 may be implemented and configured in a same or similar manner to that shown herein for entertainment device 614 of FIG. 6.

In the FIG. 6 embodiment, entertainment device 614 may include an input/output processor (IOP) 646 that coordinates transfers of various types of information for entertainment device 614. In the FIG. 6 embodiment, IOP 646 may communicate with a central processing unit (CPU) 618 via path 650. In addition, IOP 646 may communicate with a hard disk drive (HDD) 664 via path 668, and with various types of non-volatile memory devices 672 via path 676. In the FIG. 6 embodiment, non-volatile memory devices 672 may include, but are not limited to, compact disks, memory sticks, and floppy disks.

In the FIG. 6 embodiment, IOP 646 may also communicate with various external devices 688 via path 684, I/O interfaces 680, and path 692. External devices 688 may include any appropriate electronic entities that may be coupled to entertainment device 614. For example, in certain embodiments, external devices 688 may include various types of electronic devices that support an IEEE 1394 interconnectivity standard, or a Universal Serial Bus (USB) standard. In addition, in the FIG. 6 embodiment, external devices 688 may include any of the electronic devices 126 in peer-to-peer network 134 (FIG. 1). In the FIG. 6 embodiment, a device user of entertainment system 610 may exchange various types of control and user-interface communications with IOP 646 of entertainment device 614 by utilizing device controller 696 via path 698, controller interface 612, and path 616.

In the FIG. 6 embodiment, CPU 618 may communicate with random-access memory (RAM) 622 via path 626 to temporarily store or access various types of electronic information. In the FIG. 6 embodiment, CPU 618 may also provide various types of image data to television 652 via path 634, image processor 630, and path 642 for viewing by a device user of entertainment system 610. Similarly, IOP 646 may provide various types of sound data to television 652 via path 658, sound processor 654, and path 662 for use by the foregoing device user of entertainment system 610.

In the FIG. 6 embodiment, photo data source(s) 626 may provide various types of photo data to IOP 646 via path 624, photo data interface 628, and path 632. Photo data source(s) 626 may include any appropriate source of photo data in any desired and supported format. For example, photo data source(s) 626 may include, but are not limited to, various types of electronic camera devices that may capture photo data either locally or at a remote location. In certain embodiments, photo data source(s) 626 may also include other types of stationary or portable electronic devices capable of either capturing or storing photo data for subsequently downloading to entertainment device 626 by utilizing either hard-wired or wireless techniques. In the FIG. 6 embodiment, entertainment device 614 may perform various communications with device server 118 via IOP 646, path 640, network adapter 636, and communication line 614.

Referring now to FIG. 7, a block diagram for one embodiment of the FIG. 5 device memory 520 is shown, in accordance with the present invention. In the FIG. 7 embodiment, device memory 520 preferably includes, but is not limited to, a device application 712, a processing manager 716, processing rules 718, a distribution manager 720, an unprocessed data segment 324, and a processed data structure 728. In alternate embodiments, device memory 520 may readily include various other components in addition to, or instead of, those components discussed in conjunction with the FIG. 7 embodiment.

In the FIG. 7 embodiment, device application 712 may include program instructions that are preferably executed by device CPU 512 (FIG. 5) to perform various functions and operations for electronic device 126 (FIG. 1 and FIG. 5). The particular nature and functionality of device application 712 typically varies depending upon factors such as the specific type and particular functionality of the corresponding electronic device 126.

In the FIG. 7 embodiment, electronic device 126 from first-tier devices 122 (FIG. 1) may utilize processing manager 716 for converting an unprocessed data segment 324 downloaded from device server 118 into a processed data segment for populating processed data structure 728. In the FIG. 7 embodiment, processing manager 716 may utilize various processing rules 718 to convert unprocessed data segment 324 into a corresponding processed data segment. Processing rules 718 may be implemented in any appropriate and effective manner depending upon the type of information included in unprocessed data segment 324.

For example, if unprocessed data segment 324 was originally obtained from raw data 320 (FIG. 3) that included raw electronic program guide data for various type of entertainment program scheduling, then processing rules 718 may be implemented to correct various program scheduling conflicts and certain specified types of data formatting errors. Processing manager 716 may resolve conflicts and errors in unprocessed data segment 324 by applying processing rules 718 that evaluate criteria related to particular conflicts or errors to thus produce a resolution that eliminates the conflicts or errors in the form of a corresponding processed data segment.

The foregoing criteria may include any appropriate information including viewing locations, type of programming, programming source, time of day, date, and priority level of programming. In the FIG. 7 embodiment, processing rules 718 may be applied in any effective manner. For example, one or more of processing rules 718 may be implemented in an “if-then” format that specifies a particular pre-defined result when a given one or more of the criteria are true.

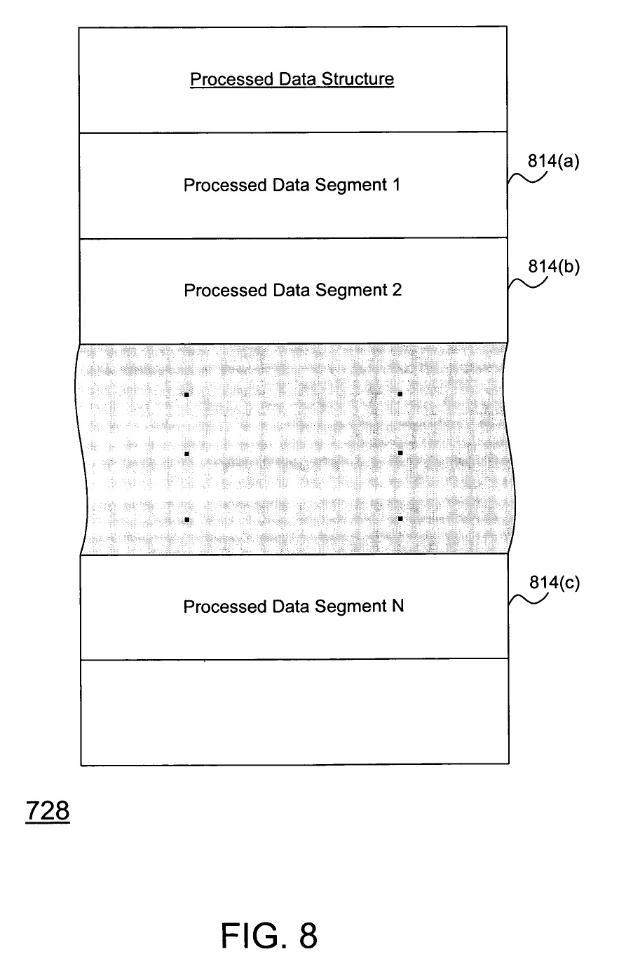

In the FIG. 7 embodiment, electronic devices 126 (FIG. 1) may each utilize a respective distribution manager 720 to perform a data reassembly procedure to populate identical processed data structures 728 of processed data segments on each of the electronic devices 126 in peer-to-peer network 134. In certain embodiments, first-tier devices 122 and second-tier devices 130 may perform the foregoing data reassembly procedure by each repetitively sending appropriate queries to other selected electronic devices 126 in peer-to-peer network 134. First-tier devices 122 and second-tier devices 130 may request any missing processed data segments for completely populating corresponding respective processed data structures 728 with a full set of the processed data segments. Implementation and reassembly of processed data structure 728 is further discussed below in conjunction with FIG. 8.

Referring now to FIG. 8, a diagram for one embodiment of the FIG. 7 processed data structure 728 is shown, in accordance with the present invention. In the FIG. 8 embodiment, processed data structure 728 may include, but is not limited to, a processed data segment 1 (814(a)) through a processed data segment N 814(c). In alternate embodiments, processed data structure 728 may readily include various other elements and functionalities in addition to, or instead of, those elements and functionalities discussed in conjunction with the FIG. 8 embodiment.

In the FIG. 8 embodiment, processed data segment 1 (814(a)) through processed data segment N 814(c) may each correspond to a respective unprocessed data segment 324 as shown in the foregoing FIG. 4 embodiment. For example, processed data segment 1 (814(a)) may correspond to unprocessed data segment 1 (324(a)), processed data segment 2 (814(b)) may correspond to unprocessed data segment 2 (324(b)), and processed data segment N (814(c)) may correspond to unprocessed data segment N (324(c)).

In the FIG. 8 embodiment, processed data structure 728 may include any type of data that may be utilized for any appropriate purpose. For example, in an embodiment in which the raw data (FIG. 3) received from data source 114 includes raw program guide data for various types of programming, then processed data structure 728 may be implemented as an electronic program guide for utilization by corresponding device users of electronic devices 126 (FIG. 1) to select, record, and view desired programming or other types of appropriate scheduled events.

In the FIG. 8 embodiment, each electronic device 126 from first-tier devices 122 may download one of the unprocessed data segments 324 from device server 118 (FIG. 1) so that every one of the unprocessed data segments 324 are downloaded to at least one of the first-tier devices 122. Each of the first-tier devices 122 may then utilize a respective processing manager 716 to convert the respective unprocessed data segments 324 to corresponding processed data segments 814 to completely populate processed data structure 728.

In the FIG. 8 embodiment, first-tier devices 122 and second-tier devices 122 may then advantageously perform a data reassembly procedure to create identical processed data structures 728 of processed data segments 814 on each of the electronic devices 126 in peer-to-peer network 134. In the FIG. 8 embodiment, the foregoing data reassembly procedure may be performed in any appropriate manner to effectively produce a final processed data structure that includes a complete set of the different processed data segments that have been separately processed by respective first-tier devices 122.

In certain embodiments, first-tier devices 122 and second-tier devices 130 may perform the foregoing data reassembly procedure by each repetitively sending appropriate queries to other selected electronic devices 126 in peer-to-peer network 134. The first-tier devices 122 and second-tier devices 130 may request any missing processed data segments 814 for completely populating corresponding respective processed data structures 728 with a full set of the processed data segments 814.

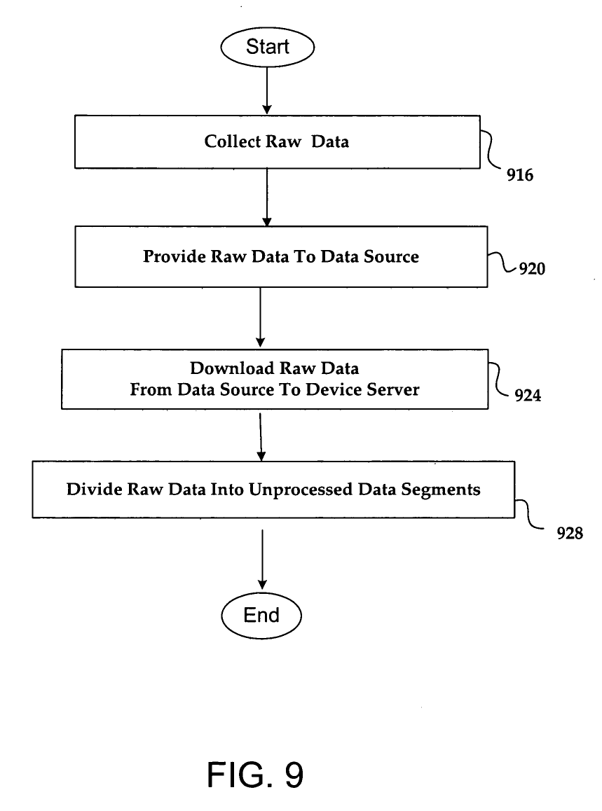

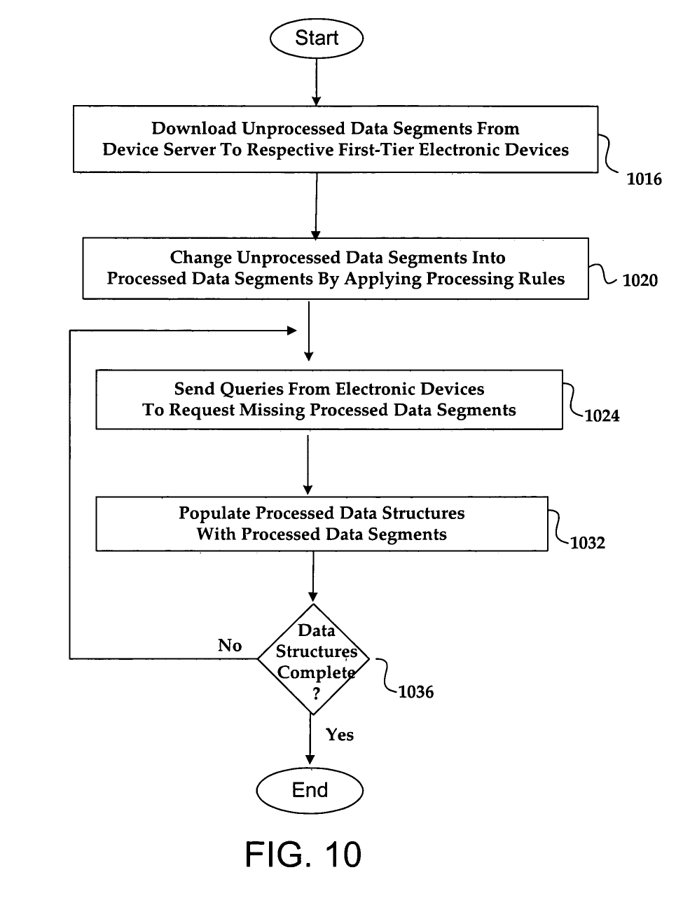

In certain embodiments, each electronic device 126 in peer-to-peer network 134 may perform the data reassembly procedure in a random manner by accessing processed data segments 814 from other electronic devices 126 in peer-to-peer network 134 in an order that is not pre-defined, chronological, or linear. In certain embodiments, during the initial data division procedure, the device server 118 (FIG. 1) may divide the raw data 320 (FIG. 3) into either chronological data segments, or into data units that each include multiple sub-segments from several of said chronological data segments. In the FIG. 8 embodiment, electronic devices 126 may each terminate the data reassembly procedure when their respective processed data structures 728 are configured with said complete sets of processed data segments 814. One embodiment for implementing processed data structure 728 on electronic devices 126 in peer-to-peer network 134 is discussed below in conjunction with FIG. 9 and FIG. 10.

Referring now to FIG. 9, a flowchart of initial method steps for implementing processed data structures 728 in an electronic network 110 is shown, in accordance with one embodiment of the present invention. The FIG. 9 flowchart is presented for purposes of illustration, and in alternate embodiments, the present invention may readily utilize various steps and sequences other than those discussed in conjunction with the FIG. 9 embodiment.

In the FIG. 9 embodiment, in step 916, any appropriate collecting entity may collect raw data 320 by utilizing any effective techniques or methodologies. For example, if raw data 320 includes raw electronic program guide data, then such raw electronic program guide data may be collected from various programming networks and related network affiliates. In step 920, the foregoing collecting entity may provide raw data 320 to a data source 114. In certain embodiments, data source 114 may be implemented as an Internet website. However, in other embodiments, data source 114 may be implemented in any other effective manner.

In step 924, a device server 118 may access data source 114 to download raw data 320 to a server memory 220 associated with device server 118. Then, in step 928, device server 118 may utilize a server application 312 or other appropriate entity to divide raw data 320 from data source 114 into corresponding unprocessed data segments 324. In the FIG. 9 embodiment, device server 118 may divide raw data 320 by utilizing any appropriate techniques. The FIG. 9 process may then proceed to step 1016 of FIG. 10.

Referring now to FIG. 10, a flowchart of final method steps for implementing processed data structures 728 in an electronic network 110 is shown, in accordance with one embodiment of the present invention. The FIG. 10 flowchart is presented for purposes of illustration, and in alternate embodiments, the present invention may readily utilize various steps and sequences other than those discussed in conjunction with the FIG. 10 embodiment.

In the FIG. 10 embodiment, in step 1016, electronic devices 126 from first-tier devices 122 in a peer-to-peer network 134 may each download a different respective unprocessed data segment 324 from device server 118. Then, in step 1020, first-tier devices 122 may perform a distributed processing procedure by each utilizing a respective processing manager 716 to change the unprocessed data segments 324 into corresponding processed data segments 814 by applying appropriate pre-determined processing rules 718.

In step 1024, first-tier devices 122 and second-tier devices 130 of peer-to-peer network 134 may begin a data reassembly procedure to produce processed data structures 728 by repeatedly sending queries to other electronic devices 126 in peer-to-peer network 134 to request missing processed data segments 814 for completing their respective processed data structures 728.

In step 1032, first-tier devices 122 and second-tier devices 130 of peer-to-peer network 134 may continue to populate their respective processed data structures 728 with processed data segments 814 received as a result of queries sent in foregoing step 1024. In step 1036, if the processed data structures 728 are not complete, then corresponding first-tier devices 122 and second-tier devices 130 may repeatedly return to prior steps 1024 and 1032 to continue with the data reassembly procedure. However, if the processed data structures 728 have been successfully populated with complete sets of processed data segments, then the FIG. 10 process may terminate.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

1. A system for efficiently implementing processed data structures, comprising:
a device server configured to divide raw data into unprocessed data segments; and
a peer-to-peer network of electronic devices that include first-tier devices and second-tier devices, each of said first-tier devices downloading one of said unprocessed data segments from said device server, said first-tier devices performing a distributed processing procedure to convert said unprocessed data segments into processed data segments, said first-tier devices and said second-tier devices then performing a data reassembly procedure through said peer-to-peer network to thereby populate said processed data structures on each of said electronic devices with complete sets of said processed data segments.

2. The system of claim 1 wherein said raw data includes entertainment program scheduling information, and wherein said processed data structures are implemented as electronic program guides.

3. The system of claim 2 wherein said raw data includes at least one data defect, said at least one data defect alternately including a program scheduling conflict and a data format error, said distributed processing procedure operating to correct said at least one data defect.

4. The system of claim 2 wherein said raw data is collected from a plurality of different entertainment scheduling sources, said raw data then being stored on an electronic data source for a subsequent downloading procedure.

5. The system of claim 2 wherein said electronic data source includes an Internet website from which said raw data may be obtained by performing said subsequent downloading procedure.

6. The system of claim 4 wherein said device server electronically communicates with said electronic data source to access and then download said raw data.

7. The system of claim 6 wherein a server application of said device server performs a data division procedure to separate said raw data into said unprocessed data segments.

8. The system of claim 6 wherein said device server performs no further processing upon said unprocessed data segments, said device server therefore being economically implemented with only moderate processing and memory resources.

9. The system of claim 7 wherein each of said first-tier devices accesses said device server to download a respective one of said unprocessed data segments, said first-tier devices thus collectively downloading all of said unprocessed data segments from said device server.

10. The system of claim 9 wherein said device server provides said unprocessed data segments only to selected ones of said electronic devices in said peer-to-peer network, said device server therefore requiring only a moderate level of communications bandwidth capability.

11. The system of claim 9 wherein said first-tier devices perform said distributed processing procedure according to pre-determined processing rules.

12. The system of claim 11 wherein said first-tier devices utilize respective processing managers for performing said distributed processing procedure to thereby alternately correct a program scheduling conflict and a data format error in said unprocessed data segments.

13. The system of claim 11 wherein one or more of said pre-determining processing rules are applied according to processing rule criteria that include a viewing location, a program type, a program source, a time of day, a current date, and a program priority level.

14. The system of claim 11 wherein one or more of said pre-determined processing rules are implemented in an “if-then” format that specifies a particular pre-defined result when a given one or more of said criteria are true.

15. The system of claim 9 wherein said first-tier devices and said second-tier devices utilize respective distribution managers for performing said data reassembly procedure to produce said processed data structures.

16. The system of claim 9 wherein said first-tier devices and said second-tier devices perform said data reassembly procedure by each sending appropriate queries to other selected electronic devices in said peer-to-peer network.

17. The system of claim 16 wherein said first-tier devices and said second-tier devices repetitively request any missing ones of said processed data segments from said other selected electronic devices in said peer-to-peer network.

18. The system of claim 17 wherein said first-tier devices and said second-tier devices each iteratively populate respective ones of said processed data structures with said processed data segments during said data reassembly procedure.

19. The system of claim 17 wherein said first-tier devices and said second-tier devices perform said data reassembly procedure in said peer-to-peer network by utilizing bi-directional peer-to-peer communications techniques.

20. The system of claim 18 wherein said first-tier devices and said second-tier devices terminate said data reassembly procedure when said processed data structures are configured with said complete sets of said processed data segments, said processed data structures then being ready for corresponding system users to utilize as said electronic program guides.

21. A method for efficiently implementing processed data structures, comprising the steps of:
dividing raw data into unprocessed data segments by utilizing a device server;
implementing a peer-to-peer network of electronic devices that include first-tier devices and second-tier devices, each of said first-tier devices downloading one of said unprocessed data segments from said device server;
performing a distributed processing procedure with said first-tier devices to convert said unprocessed data segments into processed data segments; and
performing a data reassembly procedure with said first-tier devices and said second-tier devices through said peer-to-peer network to thereby populate said processed data structures on each of said electronic devices with complete sets of said processed data segments.

22. The method of claim 21 wherein said raw data includes entertainment program scheduling information, and wherein said processed data structures are implemented as electronic program guides.

23. The method of claim 22 wherein said raw data includes at least one data defect, said at least one data defect alternately including a program scheduling conflict and a data format error, said distributed processing procedure operating to correct said at least one data defect.

24. The method of claim 22 wherein said raw data is collected from a plurality of different entertainment scheduling sources, said raw data then being stored on an electronic data source for a subsequent downloading procedure.

25. The method of claim 22 wherein said electronic data source includes an Internet website from which said raw data may be obtained by performing said subsequent downloading procedure.

26. The method of claim 24 wherein said device server electronically communicates with said electronic data source to access and then download said raw data.

27. The method of claim 26 wherein a server application of said device server performs a data division procedure to separate said raw data into said unprocessed data segments.

28. The method of claim 26 wherein said device server performs no further processing upon said unprocessed data segments, said device server therefore being economically implemented with only moderate processing and memory resources.

29. The method of claim 27 wherein each of said first-tier devices accesses said device server to download a respective one of said unprocessed data segments, said first-tier devices thus collectively downloading all of said unprocessed data segments from said device server.

30. The method of claim 29 wherein said device server provides said unprocessed data segments only to selected ones of said electronic devices in said peer-to-peer network, said device server therefore requiring only a moderate level of communications bandwidth capability.

31. The method of claim 29 wherein said first-tier devices perform said distributed processing procedure according to pre-determined processing rules.

32. The method of claim 31 wherein said first-tier devices utilize respective processing managers for performing said distributed processing procedure to thereby alternately correct a program scheduling conflict and a data format error in said unprocessed data segments.

33. The method of claim 31 wherein one or more of said pre-determining processing rules are applied according to processing rule criteria that include a viewing location, a program type, a program source, a time of day, a current date, and a program priority level.

34. The method of claim 31 wherein one or more of said pre-determined processing rules are implemented in an “if-then” format that specifies a particular pre-defined result when a given one or more of said criteria are true.

35. The method of claim 29 wherein said first-tier devices and said second-tier devices utilize respective distribution managers for performing said data reassembly procedure to produce said processed data structures.

36. The method of claim 29 wherein said first-tier devices and said second-tier devices perform said data reassembly procedure by each sending appropriate queries to other selected electronic devices in said peer-to-peer network.

37. The method of claim 36 wherein said first-tier devices and said second-tier devices repetitively request any missing ones of said processed data segments from said other selected electronic devices in said peer-to-peer network.

38. The method of claim 37 wherein said first-tier devices and said second-tier devices each iteratively populate respective ones of said processed data structures with said processed data segments during said data reassembly procedure.

39. The method of claim 37 wherein said first-tier devices and said second-tier devices perform said data reassembly procedure in said peer-to-peer network by utilizing bi-directional peer-to-peer communications techniques.

40. The method of claim 38 wherein said first-tier devices and said second-tier devices terminate said data reassembly procedure when said processed data structures are configured with said complete sets of said processed data segments, said processed data structures then being ready for corresponding system users to utilize as said electronic program guides.

41. A system for efficiently implementing processed data structures, comprising:
means for dividing raw data into unprocessed data segments;
means for implementing a peer-to-peer network of electronic devices that include first-tier devices and second-tier devices, each of said first-tier devices downloading one of said unprocessed data segments from said device server;
means for performing a distributed processing procedure to convert said unprocessed data segments into processed data segments according to pre-determined processing rules; and
means for performing a data reassembly procedure through said peer-to-peer network to thereby populate said processed data structures on each of said electronic devices with complete sets of said processed data segments.

42. A system for efficiently implementing processed data structures, comprising:
a device server configured to divide raw data into unprocessed data segments; and
a peer-to-peer network of electronic devices that include first-tier devices and second-tier devices, each of said first-tier devices downloading one of said unprocessed data segments from said device server, said first-tier devices performing a distributed processing procedure to convert said unprocessed data segments into processed data segments according to pre-determined processing rules.

43. The system of claim 42 wherein said first-tier devices and said second-tier devices perform a data reassembly procedure through said peer-to-peer network to thereby populate said processed data structures on each of said electronic devices with complete sets of said processed data segments.

44. A system for efficiently implementing processed data structures, comprising:
a device server configured to divide raw data into data segments; and
a peer-to-peer network of electronic devices that include first-tier devices and second-tier devices, each of said first-tier devices downloading one of said data segments from said device server, said first-tier devices and said second-tier devices performing a data reassembly procedure through said peer-to-peer network to thereby populate said processed data structures on each of said electronic devices with complete sets of said data segments.

45. The system of claim 44 wherein said first-tier devices perform a distributed processing procedure to process said data segments according to pre-determined processing rules before performing said data reassembly procedure.

46. A method for efficiently implementing processed data structures, comprising the steps of:
dividing raw data into unprocessed data segments;
downloading respective ones of said unprocessed data segments to first-tier devices;
converting said unprocessed data segments into processed data segments;
and
populating said processed data structures on said first-tier devices and on second-tier devices with complete sets of said processed data segments.

47. A system for efficiently implementing processed data structures, comprising:
a device server configured to divide raw data into unprocessed data segments by performing a data division procedure; and
a peer-to-peer network of electronic devices wherein certain of said devices download respective ones of said unprocessed data segments from said device server for performing a distributed processing procedure to convert said unprocessed data segments into processed data segments, said electronic devices then performing a data reassembly procedure through said peer-to-peer network to thereby populate respective ones of said processed data structures on each of said electronic devices with complete sets of said processed data segments.

48. The system of claim 47 wherein each of said electronic devices performs said data reassembly procedure in a random manner by accessing said processed data structures from other ones of said electronic devices in an order that is not pre-defined, chronological, or linear.

49. The system of claim 47 wherein said device server divides said raw data into either chronological data segments, or into data units that each include multiple sub-segments from several of said chronological data segments.

50. The system of claim 47 wherein said electronic devices perform said data reassembly procedure by sending queries to other selected electronic devices in said peer-to-peer network, said electronic devices terminating said data reassembly procedure when said processed data structures are configured with said complete sets of said processed data segments.
